(19) United States
(12) Patent Application Publication
(10) Pub. No.: US 2022/0351640 A1
(43) Pub. Date: Nov. 3, 2022

(54) METHOD OF SUPPORTING LEARNING OF PROGRAMMING, APPARATUS AND COMPUTER-READABLE STORAGE MEDIUM

(71) Applicant: Preferred Networks, Inc., Tokyo (JP)

(72) Inventor: Yuki NISHIZAWA, Tokyo (JP)

(21) Appl. No.: 17/813,358

(22) Filed: Jul. 19, 2022

Related U.S. Application Data
(63) Continuation of application No. PCT/JP2021/002856, filed on Jan. 27, 2021.

(30) Foreign Application Priority Data
Jan. 29, 2020 (JP) 2020-012647

(51) Int. Cl. G09B 19/00; G06F 3/0484; G06F 8/34

(52) U.S. Cl. CPC G09B 19/0053; G06F 3/0484; G06F 8/34

(57) ABSTRACT

According to one aspect of the present disclosure, a method of supporting a learning of programming includes determining, by at least one processor, a user interface for providing a block-based programming environment, from among a plurality of user interfaces for providing respective block-based programming environments, and displaying, by the at least one processor, the determined programming interface as the block-based programming environment. The plurality of user interfaces for providing the respective block-based programming environments include a first user interface for providing a first block-based programming environment where a label of a block is described in a predetermined natural language and a second user interface for providing a second block-based programming environment where a label of a block is described in a predetermined text programming language.

### CROSS-REFERENCE TO RELATED APPLICATIONS

This application is a continuation application of International Application No. PCT/JP2021/002856 filed on Jan. 27, 2021, and designating the U.S., which is based upon and claims priority to Japanese Patent Application No. 2020-012647, filed on Jan. 29, 2020, the entire contents of which are incorporated herein by reference.

### BACKGROUND

### 1. Technical Field

The present disclosure relates to a programming learning support method, a programming learning support apparatus, and a computer-readable storage medium.

### 2. Description of the Related Art

Visual programming languages such as Scratch and Blockly are used to learn programming for children or beginners. In these visual programming languages, a block for giving instructions, control structures, and the like is provided as a component of the program, and the user can create a program by manipulating a mouse or the like on a user interface for visual programming and combining the blocks.

The shape of the block is specified according to the block type, and each block is colored in various colors. Further, expressions in the blocks are described not only in English but also in Japanese so that users who do not speak English as their native language can easily understand. This allows a user who does not use English as a native language to learn and acquire programming languages without language barriers, as compared to script-based text programming languages such as C and Python (registered trademark).

Meanwhile, users using visual programming languages often have difficulty transitioning to using text programming languages.

### RELATED-ART DOCUMENTS

### Patent Documents

Patent Document 1: Japanese Patent No. 6543785

### SUMMARY

The purpose of the present disclosure is to provide programming learning support technology to support a smooth transition between different programming languages in learning programming.

According to one aspect of the present disclosure, a method of supporting a learning of programming includes determining, by at least one processor, a user interface for providing a block-based programming environment, from among a plurality of user interfaces for providing respective block-based programming environments, and displaying, by the at least one processor, the determined programming interface as the block-based programming environment. The plurality of user interfaces for providing the respective block-based programming environments include a first user interface for providing a first block-based programming environment where a label of a block is described in a predetermined natural language and a second user interface for providing a second block-based programming environment where a label of a block is described in a predetermined text programming language.

According to one aspect of the present disclosure, a method of supporting a learning of programming includes converting, by at least one processor, a first user interface for programming according to a first color scheme to a second user interface for programming according to a second color scheme of a different color set from the first color scheme, and displaying, by the at least one processor, the second user interface for programming.

### BRIEF DESCRIPTION OF THE DRAWINGS

FIG. 1A is a schematic diagram illustrating a conversion example of a user interface according to an embodiment of the present disclosure;

FIG. 1B is a schematic diagram illustrating a conversion example of the user interface according to an embodiment of the present disclosure;

FIG. 2 is a block diagram illustrating a functional configuration of a programming learning support apparatus according to an embodiment of the present disclosure;

FIG. 3 is a diagram illustrating a color conversion rule according to an embodiment of the present disclosure;

FIG. 4 is a diagram illustrating a label conversion rule according to an embodiment of the present disclosure;

FIG. 5 is a diagram illustrating an example of a label conversion according to an embodiment of the present disclosure;

FIG. 6 is a diagram illustrating an example of a label conversion according to an embodiment of the present disclosure;

FIG. 7 is a flowchart illustrating a programming learning support process according to an embodiment of the present disclosure; and

FIG. 8 is a block diagram illustrating a hardware configuration of a programming learning support apparatus according to an embodiment of the present disclosure.

### DETAILED DESCRIPTION

In the following, embodiments of the present disclosure will be described with reference to the drawings. In the following examples, a programming learning support apparatus that converts a user interface for a predetermined visual programming language to a user interface for a predetermined text (textual) programming language, such as C, Python, or the like is disclosed. In other words, in the following embodiment, a programming learning support apparatus for converting the visual programming user interface to a text programming style is disclosed.

### [Outline of Present Disclosure]

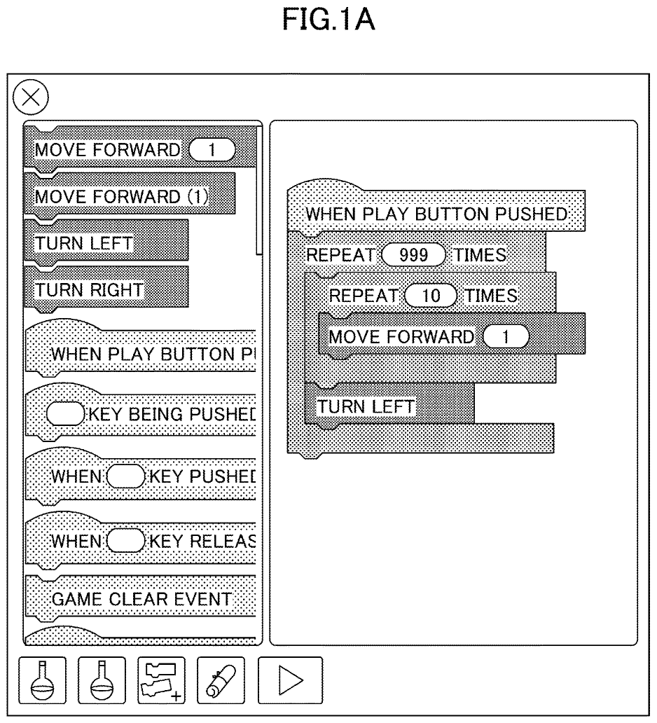

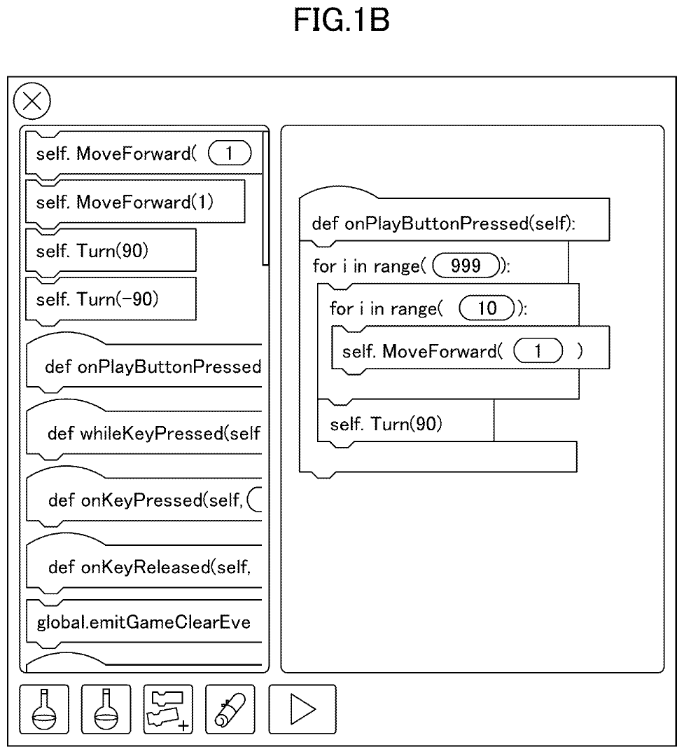

A programming learning support apparatus 100 according to an embodiment of the present disclosure converts a visual programming user interface as illustrated in FIG. 1A to a text programming style user interface for visual programming (hereinafter referred to as a text programming style user interface) as illustrated in FIG. 1B. In the following examples, the text programming language is Python. As illustrated, in the visual programming user interface, blocks that are components of the program are displayed in a shape according to the block type, and an expression in the block can be described in a non-English language, such as Japanese. For example, when a user who is performing programming with the visual programming user interface illustrated in FIG. 1A clicks a predetermined user interface switching button, the programming learning support apparatus 100 converts the displayed visual programming user interface to a corresponding text programming style user interface. Then the text programming style user interface is displayed instead of or in addition to the visual programming user interface, as illustrated in FIG. 1B. Hereinafter, the user interface is abbreviated as UI.

Here, in the visual programming UI, the blocks are distinguished by color according to the block type, while in the text programming style UI, the blocks are displayed by a color scheme of fewer color sets, such as black and white. Note that in the drawings, different hatches represent different color sets. Further, the programming learning support apparatus 100 according to the present disclosure is not limited to converting a first visual programming UI to a second visual programming UI which is a text programming style UI, but may be applied similarly to the conversion of different programming UIs by different color schemes.

As described above, coloring is performed by a different color set for each block type such as Scratch and Blockly, and a user learns a visual programming language with such blocks distinguished by color. According to the programming learning support apparatus 100, the user can be assisted to smoothly transition to learn a text programming language, such as C and Python, that is displayed in fewer color sets (for example, black and white).

### [Programming Learning Support Apparatus]

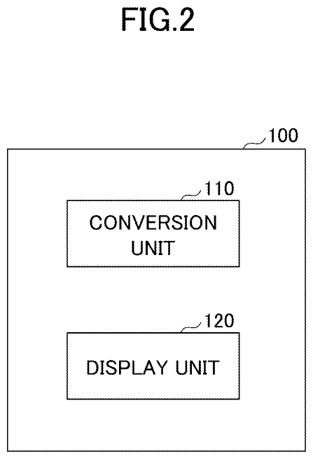

Next, the programming learning support apparatus 100 according to an embodiment of the present disclosure will be described with reference to FIG. 2 to FIG. 6. FIG. 2 is a block diagram illustrating a functional configuration of the programming learning support apparatus 100 according to an embodiment of the present disclosure.

As illustrated in FIG. 2, the programming learning support apparatus 100 includes a conversion unit 110 and a display unit 120.

The conversion unit 110 converts a first programming UI according to a first color scheme to a second programming UI according to a second color scheme of a different color set from the first color scheme. Here, the difference between the first color scheme and the second color scheme means that the color set of the first color scheme and the color set of the second color scheme do not completely match each other, and the color set of the first color scheme and the second color scheme may partially match each other. That is, when the first color scheme is composed of {white, black, red, blue, yellow}, the second color scheme may be composed of {white, black}.

For example, the conversion unit 110 may convert a visual programming UI for a block-based visual programming language to a text programming style UI for a script-based text programming language such as Python or C. Here, the visual programming UI displays blocks colored by block type, while the text programming style UI may display blocks with fewer color sets (e.g., black and white, or the like).

The display unit 120 displays the second programming UI converted by the conversion unit 110. Specifically, the display unit 120 displays the text programming style UI converted from the visual programming UI by the conversion unit 110 to a user. For example, the display unit 120 may display the text programming style UI instead of the visual programming UI on the screen. Alternatively, the display unit 120 may display the text programming style UI in addition to the visual programming UI on the screen. However, a display method according to the present disclosure is not limited to these, and any other appropriate display method may be used.

For example, the conversion unit 110 may convert the visual programming UI to the text programming style UI according to a predetermined conversion rule.

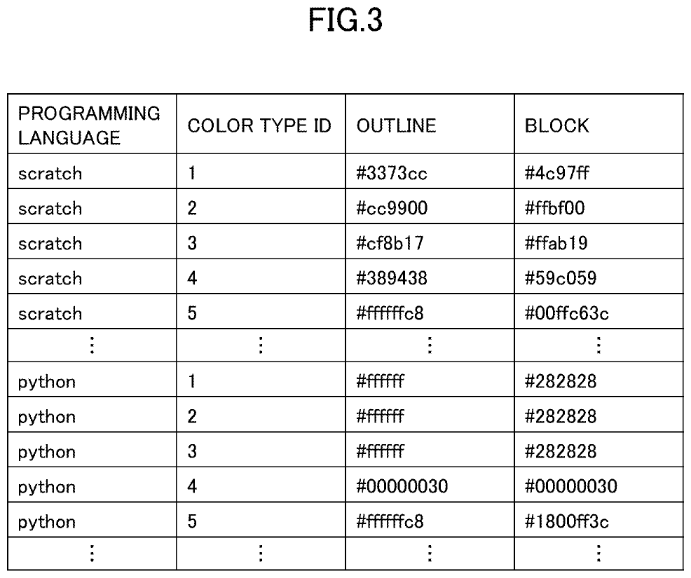

In one embodiment, a predetermined conversion rule may be a color conversion rule, such as that illustrated in FIG. 3, in which the illustrated color conversion rule specifies a type of programming language, a color set ID assigned to each block or the like, an RGB indicating a color of the outline of the block, and an RGB indicating a color inside of the block. For example, when converting the visual programming UI from a Scratch style to a Python style, the outline color “#3373cc” and the inside color “#4c97ff” of the block assigned to the color set ID=1 in the Scratch style UI is converted to the outline color “#ffffff” and the inside color “#282828” of the block in the Python style UI. Similarly, the outline color “#cc990038 and the inside color “#ffbf00” of the block assigned to the color set ID=2 in the Scratch style UI are converted to the outline color “#ffffff” and the inside color “#282828” of the block in the Python style UI. Similarly, each of the outline color and the inside color of the block assigned to the color set ID=3, 4, . . . in the Scratch style UI is converted to the outline color and the inside color of the block in the Python style UI, according to the color conversion rule illustrated in FIG. 3. In this way, the conversion unit 110 may convert the color of each element (for example, a block in Scratch) in the visual programming UI to the color of the text programming style UI.

It should be noted that the color conversion rule illustrated in FIG. 3 specifies rules for converting from the Scratch style UI to the Python style UI, but the color conversion rule according to the present disclosure is not limited to this. For example, the color conversion rule may specify rules for converting from the Scratch style UI to the Python style UI as well as to a C programming language style UI, or may specify a conversion between two or more different programming languages.

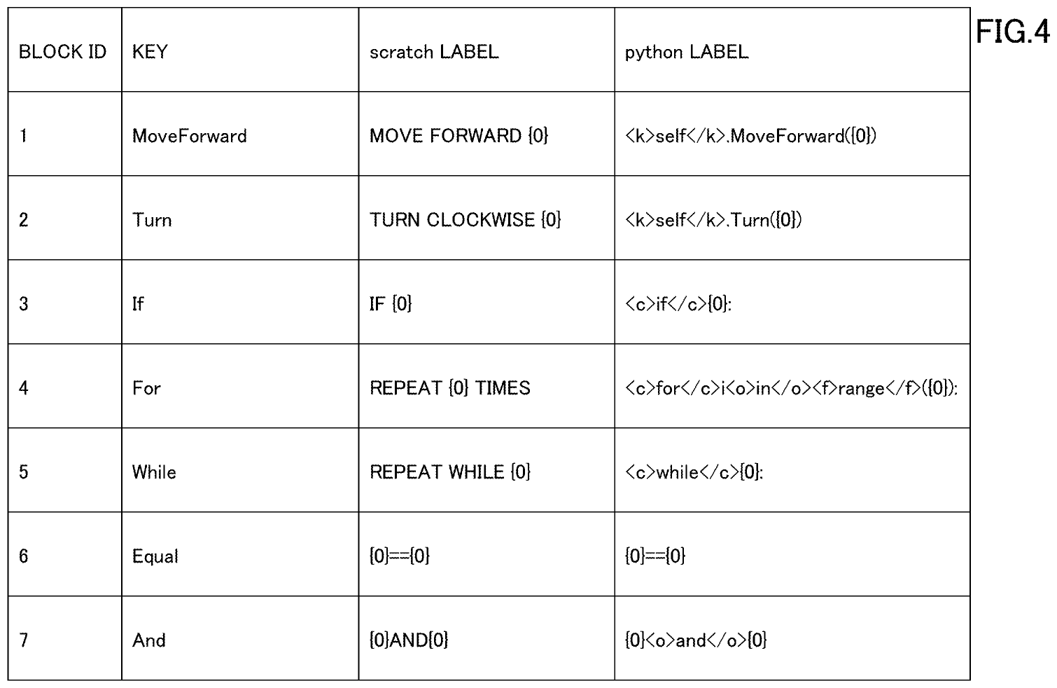

Further, in another embodiment, the predetermined conversion rule may be a label conversion rule as illustrated in FIG. 4, in which the illustrated label conversion rule specifies: a block ID; an instruction, a control structure, or the like in the block; a Scratch label indicating an expression in the Scratch style UI of the instruction, the control structure, or the like; a Python label indicating an expression in the Python style UI of the instruction, the control structure, or the like.

Here, the label conversion may be activated, for example, by clicking the “Switch” button, a user setting set in advance, or the like. Alternatively, when the user is learning the text programming language from the visual programming language through a game or the like, the switching may be automatically performed by a transition of the game stage or the like. For example, the user initially learns programming by using the Scratch style UI, but the user may switch to the Python style UI upon clearing a specific stage.

For example, when converting from the Scratch style UI to the Python style UI, a label “MoveForward({0})” of the block whose block ID=1 in the Scratch style UI is displayed as “self.MoveForward({0})” in the Python style UI. Similarly, a label “Turn clockwise by {0} degrees” of the block whose block ID=2 in the Scratch style UI is displayed as “self.Turn({0})” in the Python style UI. Similarly, labels of the block whose block ID=3, 4, . . . in the Scratch style UI are converted to corresponding labels in the Python style UI according to the illustrated label conversion rule. In this way, the conversion unit 110 may convert the label of each element (for example, a block in Scratch) in the visual programming UI to the label of the text programming style UI.

In one embodiment, the conversion unit 110 may convert the label of the element in response to a predetermined operation with respect to the element. Specifically, the conversion unit 110 may convert the label of the block in response to a predetermined user operation with respect to the block displayed in the visual programming UI or in the text programming style UI.

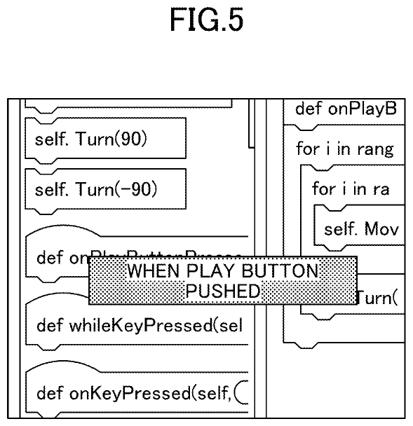

For example, as illustrated in FIG. 5, when a user moves a mouse cursor to a block “def onPlayButtonPressed”, the conversion unit 110 superimposes a label “When Play Button is Pressed” on the block according to the label conversion rule, and the display unit 120 may display the superimposed label.

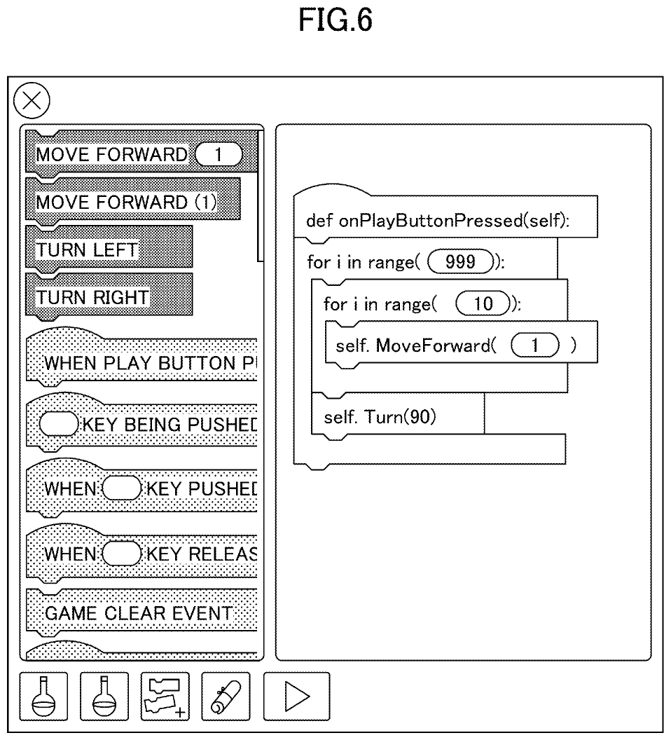

Alternatively, as illustrated in FIG. 6, when a user selects a block from a block list screen on the left side and moves the block to a work screen on the right side in order to create a program, the conversion unit 110 converts the selected block according to the label conversion rule, and the display unit 120 may display the block with the converted label.

### [Programming Learning Support Process]

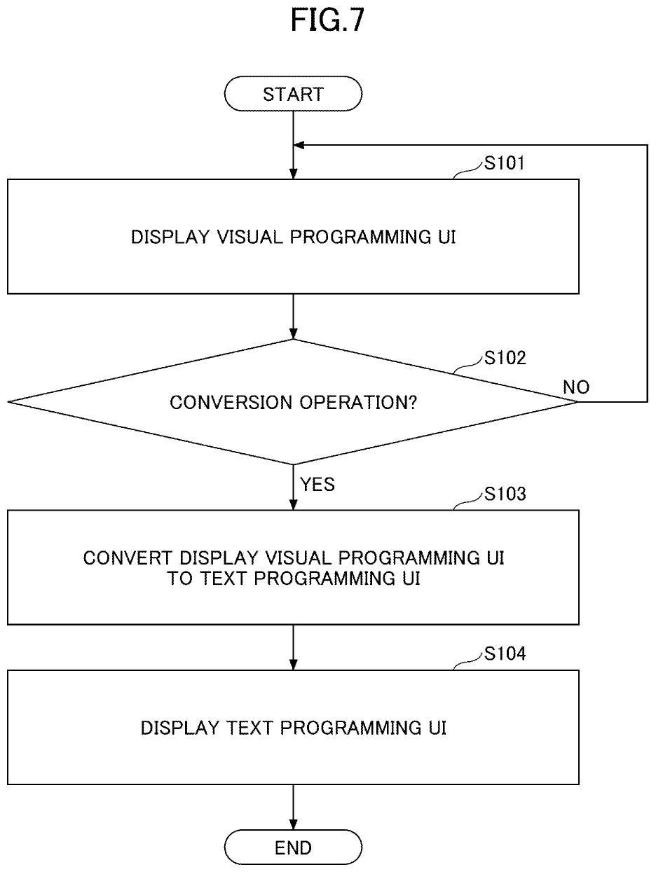

Next, a programming learning support process according to an embodiment of the present disclosure will be described with reference to FIG. 7. The programming learning support process may be implemented by the programming learning support apparatus 100 described above, for example, by executing a program or instruction in which one or more processors or processing circuits of the programming learning support apparatus 100 are stored in a memory. FIG. 7 is a flowchart illustrating a programming learning support process according to an embodiment of the present disclosure.

As illustrated in FIG. 7, in step S101, the programming learning support apparatus 100 displays a predetermined visual programming UI. For example, the predetermined visual programming UI may provide a programming environment in a block-based visual programming language such as Scratch, Blockly, or the like.

In step S102, the programming learning support apparatus 100 determines whether a predetermined conversion operation has been performed. For example, the predetermined conversion operation may be a clicking of a switch button or a mouse gesture of a mouse cursor (not illustrated) by the user.

When the predetermined conversion operation is performed (S102: YES), the programming learning support apparatus 100 converts the visual programming UI to the text programming style UI in step S103. For example, the text programming style UI may provide a programming environment in a script-based text programming language such as Python, C programming language, and the like. Specifically, the programming learning support apparatus 100 converts the color and/or label of an element, such as a block, in the visual programming UI according to a predetermined conversion rule such as the color conversion rule and the label conversion rule, and generates a corresponding text programming style UI with the converted element.

On the other hand, when the predetermined conversion operation is not performed (S102: NO), the programming learning support apparatus 100 returns to step S101 and continues to display the visual programming UI until the predetermined conversion operation is detected.

In step S104, the programming learning support apparatus 100 displays the text programming style UI generated in step S103. For example, the programming learning support apparatus 100 may display the text programming style UI together with the visual programming UI, or may display the text programming style UI instead of the visual programming UI. If the pressing of the switching button is detected again while the text programming style UI is being displayed, the programming learning support apparatus 100 returns to S101 and displays the predetermined visual programming UI.

When the predetermined conversion operation is accepted, the programming learning support apparatus 100 may convert the color scheme and the label of the block displayed on the block list screen on the left side in FIG. 7 to the text programming style UI in accordance with the work screen on the right side.

### [Hardware Configuration]

A part of or all of the programming learning support apparatus 100 in the aforementioned embodiment may comprise hardware, or may comprise information processing of software (programs) executed by a Central Processing Unit (CPU) or a Graphics Processing Unit (GPU). In the case of being configured with information processing by software, software that implements at least some of the functions of the devices in the embodiment may be recorded on a non-transitory recording medium such as a flexible disk, a Compact Disc Read-Only Memory (CD-ROM), a Universal Serial Bus (USB) memory, or the like, and loaded into a computer to execute the information processing by the software. Further, the software may be downloaded via a communication network. Further, information processing may be executed by hardware by implementing the software in a circuit such as an Application Specific Integrated Circuit (ASIC), a Field Programmable Gate Array (FPGA), or the like.

The type of recording medium to record the software is not limited. The recording medium is not limited to an attachable/detachable medium such as a magnetic disk, an optical disk, or the like, and may be a fixed recording medium such as a hard disk, a memory, or the like. Also, the recording medium may be provided in the computer, or may be provided external to the computer.

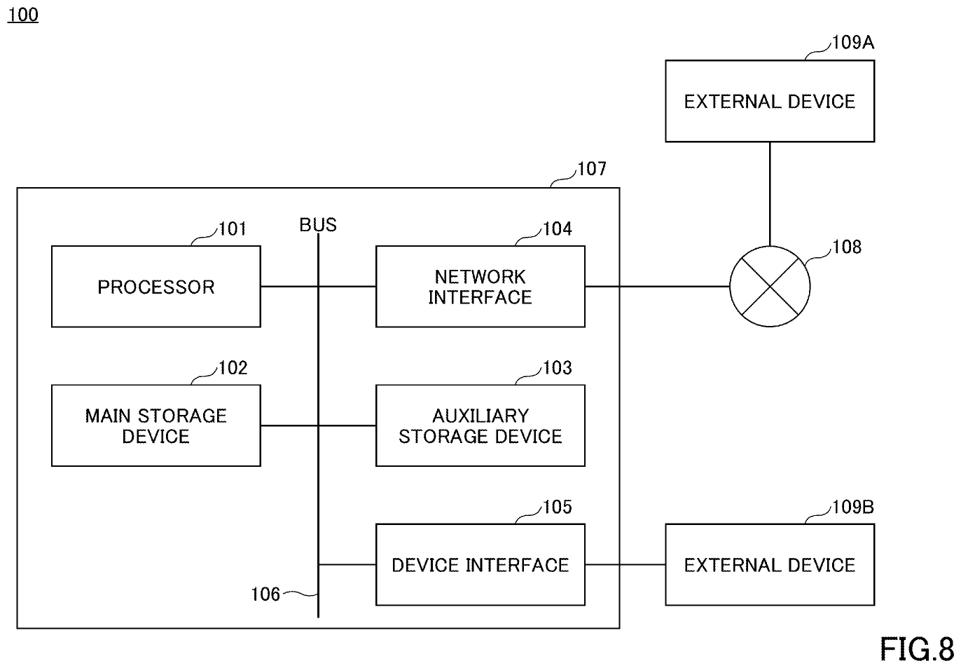

FIG. 8 is a block diagram illustrating an example of a hardware configuration of the programming learning support apparatus 100 according to the aforementioned embodiment. The programming learning support apparatus 100 includes, by way of example, a processor 101, a main storage device 102, an auxiliary storage device 103, a network interface 104, and a device interface 105, which may be implemented as a computer 107 connected via a bus 106.

The computer 107 in FIG. 8 is provided with one of each component but may be provided with a plurality of a same component. Although one computer 107 is illustrated in FIG. 8, the software may be installed on a plurality of computers, and each of the plurality of computers may execute the same or a different part of the software processing. In this case, it may be in a form of distributed computing where each of the computers communicates with each of the computers through the network interface 104 and the like to execute the processing. That is, the programming learning support apparatus 100 in the aforementioned embodiment may be configured as a system where one or more computers execute the instructions stored in one or more storages to enable functions. Each apparatus may be configured such that the information transmitted from a terminal is processed by one or more computers provided on a cloud and results of the processing are transmitted to the terminal.

Various arithmetic operations of the programming learning support apparatus 100 in the aforementioned embodiment may be executed in parallel processing using one or more processors or using a plurality of computers over a network. The various arithmetic operations may be allocated to a plurality of arithmetic cores in the processor and executed in parallel processing. Some or all of the processes, means, and the like of the present disclosure may be executed by at least one of the processor and the storage device provided on a cloud that can communicate with the computer 107 through a network. Thus, each apparatus in the aforementioned embodiment may be in a form of parallel computing by one or more computers.

The processor 101 may be an electronic circuit (such as a processing circuit, a processing circuitry, a CPU, a GPU, an FPGA, or an ASIC) that includes a control device and an arithmetic device of a computer. The processor 101 may also be a semiconductor device or the like including a dedicated processing circuit. The processor 101 may not be limited to the electronic circuits using electronic logic elements but may be enabled by optical circuits using optical logic elements. The processor 101 may also include an arithmetic function based on quantum computing.

The processor 101 can execute arithmetic processing based on data and software (programs) input from each device, and the like of the internal configuration of the computer 107, and can output arithmetic results and control signals to each device, and the like. The processor 101 may control each component of the computer 107 by executing an operating system (OS), applications, and the like of the computer 107.

The programming learning support apparatus 100 in the aforementioned embodiment may be enabled by one or more processors 101. The processor 101 may refer to one or more electronic circuits located on one chip or one or more electronic circuits located on two or more chips or two or more devices. When a plurality of electronic circuits are used, each electronic circuit may communicate by wired or wireless.

The main storage device 102 is a storage device for storing instructions to be executed by the processor 101, various data, and the like, and the information stored in the main storage device 102 is read out by the processor 101. The auxiliary storage device 103 is a storage device other than the main storage device 102. These storage devices shall mean any electronic component capable of storing electronic information and may be a semiconductor memory. The semiconductor memory may be either a volatile or non-volatile memory. The storage device for storing various data in the programming learning support apparatus 100 in the aforementioned embodiment may be enabled by the main storage device 102 or auxiliary storage device 103 or may be enabled by a built-in memory built into the processor 101. For example, the storages in the aforementioned embodiment may be implemented by the main storage device 102 or the auxiliary storage device 103.

A plurality of processors may be connected (coupled) or a single processor may be connected to a single storage device (memory). A plurality of storage devices (memories) may be connected (coupled) to one processor. When the programming learning support apparatus 100 in the aforementioned embodiment is configured by at least one storage device (memory) and a plurality of processors connected (coupled) to this at least one storage device (memory), a configuration where at least one of the plurality of processors is connected (coupled) to the at least one storage device (memory) may be included. This configuration may also be enabled by storage devices (memories) included in a plurality of computers and a processor. Further, a configuration where a storage device (memory) is integrated with a processor (for example, a cache memory including an L1 cache and an L2 cache) may be included.

The network interface 104 is an interface for connecting to a communication network 108 by wireless or wired. The network interface 104 may be compatible with existing communication standards. The network interface 104 may exchange information with an external device 109A connected through the communication network 108. The communication network 108 may be any one of a wide area network (WAN), a local area network (LAN), a personal area network (PAN), or a combination thereof, in which information is exchanged between the computer 107 and the external device 109A. Examples of the WAN include the Internet, examples of the LAN include IEEE 802.11 and Ethernet (registered trademark), and examples of the PAN include Bluetooth (registered trademark) and near field communication (NFC).

The device interface 105 is an interface, such as a USB, that directly connects to an external device 109B.

The external device 109A is a device connected to the computer 107 via a network. The external device 109B is a device connected directly to the computer 107.

The external device 109A or the external device 109B may be, for example, an input device. The input device may be, for example, a camera, a microphone, a motion capture, various sensors, a keyboard, a mouse, or a touch panel or the like, and provides obtained information to the computer 107. Further, the input device may also be a device including an input unit, a memory, and a processor, such as a personal computer, a tablet terminal, or a smartphone.

The external device 109A or the external device 109B may be, for example, an output device. The output device may be, for example, a display device, such as a liquid crystal display (LCD), a cathode-ray tube (CRT), a plasma display panel (PDP), or an organic electro luminescence (EL) panel, or may be a speaker or the like that outputs the voice. Further, the output device may also be a device including an output unit, a memory, and a processor, such as a personal computer, a tablet terminal, or a smartphone.

The external device 109A or the external device 109B may be a storage device (i.e., a memory). For example, the external device 109A may be a storage such as a network storage, and the external device 109B may be a storage such as an HDD.

The external device 109A or the external device 109B may also be a device having a function of a component of the programming learning support apparatus 100 in the aforementioned embodiment. That is, the computer 107 may transmit or receive some or all of the processed results of the external device 109A or the external device 109B.

In the present disclosure (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present disclosure (including the claims), if the expression such as “data as an input”, “based on data”, “according to data”, or “in accordance with data” (including similar expressions) is used, unless otherwise noted, a case in which various data itself is used as an input and a case in which data obtained by processing various data (e.g., data obtained by adding noise, normalized data, and intermediate representation of various data) is used as an input are included. If it is described that any result can be obtained “based on data”, “according to data”, or “in accordance with data”, a case in which a result is obtained based on only the data is included, and a case in which a result is obtained affected by another data other than the data, factors, conditions, and/or states may be included. If it is described that “data is output”, unless otherwise noted, a case in which various data is used as an output is included, and a case in which data processed in some way (e.g., data obtained by adding noise, normalized data, and intermediate representation of various data) is used as an output is included.

In the present disclosure (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present disclosure (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporarily program (i.e., an instruction). If the element A is a dedicated processor or a dedicated arithmetic circuit, a circuit structure of the processor may be implemented so as to actually perform the operation B irrespective of whether the control instruction and the data are actually attached.

In the present disclosure (including the claims), if a term indicating containing or possessing (e.g., “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (i.e., an expression using “a” or “an” as an article), the expression should be interpreted as being not limited to a specified number.

In the present disclosure (including the claims), even if an expression such as “one or more” or “at least one” is used in a certain description, and an expression that does not specify a quantity or that suggests a singular number is used in another description (i.e., an expression using “a” or “an” as an article), it is not intended that the latter expression indicates “one”. Generally, an expression that does not specify a quantity or that suggests a singular number (i.e., an expression using “a” or “an” as an article) should be interpreted as being not necessarily limited to a particular number.

In the present disclosure, if it is described that a particular advantage/result is obtained in a particular configuration included in an embodiment, unless there is a particular reason, it should be understood that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In the present disclosure (including the claims), if multiple hardware performs predetermined processes, each of the hardware may cooperate to perform the predetermined processes, or some of the hardware may perform all of the predetermined processes. Additionally, some of the hardware may perform some of the predetermined processes while another hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present disclosure (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. Further, the order of each operation in the embodiment is presented as an example and is not limited thereto.

What is claimed is:

1. A method of supporting a learning of programming, comprising:
determining, by at least one processor, a user interface for providing a block-based programming environment, from among a plurality of user interfaces for providing respective block-based programming environments; and
displaying, by the at least one processor, the determined programming interface as the block-based programming environment,
wherein the plurality of user interfaces for providing the respective block-based programming environments include a first user interface for providing a first block-based programming environment where a label of a block is described in a predetermined natural language and a second user interface for providing a second block-based programming environment where a label of a block is described in a predetermined text programming language.

2. The method according to claim 1, wherein the predetermined natural language is a non-English natural language.

3. The method according to claim 1, wherein each of the first and second block-based programming environments displays the block as a component of a program, the label of the block in the first block-based programming environment describing a content of the component in the predetermined natural language, and the label of the block in the second block-based programming environment describing the content of the component in the predetermined text programming language.

4. The method according to claim 1, wherein the first and second block-based programming environments include the block whose function is a same, the label of the block describing the function.

5. The method according to claim 4, wherein the first block-based programming environment and the second block-based programming environment display the label of the block describing the function in the predetermined natural language and the predetermined text programming language, respectively.

6. The method according to claim 5, wherein the label of the block describing the function in the predetermined natural language and the label of the block describing the function in the predetermined text programming language are associated with each other by a predetermined rule in advance.

7. The method according to claim 1, wherein the displaying, with respect to a block having a predetermined function, displays the label of the predetermined natural language in the first user interface for programming, and displays the label of the predetermined text programming language in the second user interface for programming.

8. The method according to claim 1, wherein each of the first block-based programming environment and the second block-based programming environment includes a predetermined screen area, the first block-based programming environment provided by the first user interface displays respective labels of all blocks included in the predetermined screen area in the predetermined natural language, and the second block-based programming environment provided by the second user interface displays respective labels of all blocks included in the predetermined screen area in the predetermined text programming language.

9. The method according to claim 8, wherein the predetermined screen area is a work screen area for combining blocks to create a program in the block-based programming environment.

10. The method according to claim 9, wherein each of the first block-based programming environment and the second block-based programming environment includes a block list, and creates the program by combining blocks selected from the block list on the work screen area, and
wherein the first block-based programming environment displays a label of each block included in the block list in the predetermined natural language, and the second block-based programming environment displays a label of each block included in the block list in the predetermined text programming language.

11. The method according to claim 10, wherein the work screen area and the block list are adjacent to each other in a single screen in each of the first and second block-based programming environments.

12. The method according to claim 1, wherein the determining determines the first user interface for providing the first block-based programming environment and the second user interface for providing the second block-based programming environment, in accordance with a press of a button.

13. A method of supporting a learning of programming, comprising:
converting, by at least one processor, a first user interface for programming according to a first color scheme to a second user interface for programming according to a second color scheme of a different color set from the first color scheme; and
displaying, by the at least one processor, the second user interface for programming.

14. The method according to claim 13, wherein the converting further includes:
converting a color of an element in the first user interface for programming; and
generating the second user interface for programming according to the element whose color is converted.

15. The method according to claim 13, wherein the converting further includes:
converting a label of an element in the first user interface for programming; and
generating the second user interface for programming according to the element whose label is converted.

16. The method according to claim 15, wherein the converting includes converting the label of the element in response to a predetermined operation with respect to the element.

17. The method according to claim 13, wherein the converting further includes converting the first user interface for programming to the second user interface for programming according to a predetermined conversion rule.

18. The method according to claim 13, wherein the first user interface for programming is an interface for a predetermined visual programming language according to the first color scheme and the second user interface for programming is an interface for a predetermined text programming language according to the second color scheme composed of fewer color sets than the first color scheme.

19. An apparatus comprising:
at least one memory; and
at least one processor configured to provide a block-based programming application for learning programming,
wherein, in the block-based programming application, the at least one processor is configured to:
determine a user interface for providing a block-based programming environment, from among a plurality of user interfaces for providing respective block-based programming environments; and
display the determined programming interface as the block-based programming environment,
wherein the plurality of user interfaces for providing the respective block-based programming environments include a first user interface for providing a first block-based programming environment where a label of a block is described in a predetermined natural language and a second user interface for providing a second block-based programming environment where a label of a block is described in a predetermined text programming language.

20. A non-transitory computer-readable storage medium having stored therein a program for causing a computer to execute:
determining one of a plurality of predetermined user interfaces for providing respective block-based programming environments; and
displaying the determined programming interface as a block-based programming environment where blocks are combined into a program,
wherein the plurality of user interfaces for providing the respective block-based programming environments include a first user interface for providing a first block-based programming environment where labels of the block are described in a predetermined natural language and a second user interface for providing a second block-based programming environment where labels of the block are described in a predetermined text programming language.
